(19) United States
(12) Patent Application Publication
(10) Pub. No.: US 2024/0128019 A1
(43) Pub. Date: Apr. 18, 2024

(54) WINDING, TRANSFORMER AND SWITCHING POWER SUPPLY

(71) Applicant: AcLeap Power Inc., Taipei City (TW)

(72) Inventors: Lanlan Yin, Shanghai (CN); Yifeng Sun, Shanghai (CN); Xiaojian Zhao, Shanghai (CN)

(21) Appl. No.: 18/484,954

(22) Filed: Oct. 11, 2023

(30) Foreign Application Priority Data
Oct. 13, 2022 (CN) 202211253221.0

(51) Int. Cl. H01F 38/42; H01F 27/24; H01F 27/28

(52) U.S. Cl. CPC H01F 38/42; H01F 27/24; H01F 27/2828

(57) ABSTRACT

A winding includes one or more first magnetic poles, each has a first cross-sectional area equal to each other, and each is wound with a first primary side winding and a first secondary side winding. Each of the first primary side windings has a first number of primary side turns equal to each other, and each of the first secondary side windings has a first number of secondary side turns equal to each other. One or more second magnetic poles each have a second cross-sectional area equal to each other, and each is wound with a second primary side winding and a second secondary side winding. Each of the second primary side windings has a second number of primary side turns equal to each other, and each of the second secondary side windings has a second number of secondary side turns equal to each other.

### CROSS-REFERENCE TO RELATED APPLICATIONS

This application claims priority to Chinese Patent Application No. 202211253221.0, filed on Oct. 13, 2022, and titled “WINDING, TRANSFORMER AND SWITCHING POWER SUPPLY”, which is hereby incorporated by reference in its entirety.

### BACKGROUND

Embodiments of the present disclosure relate to the electrical field, and more particularly, to a winding having a flexible winding arrangement, and a transformer and a switching power supply including such a winding.

In the field of transformers, a turns ratio of a primary and a secondary side of the transformer is a crucial parameter. In applications with large output current, the number of winding turns on the secondary side is usually only one. In this case, the turns ratio of the primary and secondary sides is limited to N:1, where N is a positive integer. However, the ideal turns ratio should be related to the input current on the primary side and the output current on the secondary side. For example, in a usage scenario where the input voltage is 54V and the output voltage is 12.2V, a more desirable turns ratio would be 54V/12.2V≈4.5:1. Such a non-integer turns ratio is difficult to achieve in prior approaches. Therefore, there is a need for a solution that enables flexible adjustment of the turns ratio in the transformer.

### BRIEF DESCRIPTION

Embodiments of the present disclosure provide a flexible, reliable, and low-cost solution for achieving a predetermined turns ratio that addresses the above-mentioned and/or other potential problems in prior approaches.

In a first aspect of the present disclosure, embodiments of the present disclosure relate to a winding for a transformer. The winding includes: one or more first magnetic poles each having a first cross-sectional area equal to each other and each wound with a first primary side winding and a first secondary side winding, wherein the first primary side windings each has a first number of primary side turns equal to each other and the first secondary side windings each has a first number of secondary side turns equal to each other; and one or more second magnetic poles each having a second cross-sectional area equal to each other and each wounded with a second primary side winding and a second secondary side winding, wherein the second primary side windings each has a second number of primary side turns equal to each other and the second secondary side windings each has a second number of secondary side turns equal to each other, wherein the second cross-sectional area is not equal to the first cross-sectional area.

According to embodiments of the present disclosure, a desired turns ratio of a winding can be flexibly achieved in a simple and inexpensive manner.

In some embodiments, the first number of primary side turns is not equal to the second number of primary side turns and/or the first number of secondary side turns is not equal to the second number of secondary side turns.

In some embodiments, the first cross-sectional area is N times the second cross-sectional area, N being a positive integer greater than 1.

In some embodiments, the second number of primary side turns is N times the second number of secondary side turns, N being a positive integer greater than 1.

In some embodiments, the first number of primary side turns is equal to the first number of secondary side turns. In this way the winding wires of the first winding can be wound in a stable and reliable manner.

In some embodiments, the first magnetic pole is arranged on both side poles of a U-shaped magnetic core, or the first magnetic pole is arranged on a middle pole of an E-shaped magnetic core. In this way, the first winding can be realized in various ways.

In some embodiments, the second magnetic pole is arranged on both side poles of a U-shaped magnetic core, or the second magnetic pole is arranged on a middle pole of an E-shaped magnetic core. In this way, the second winding can be realized in various ways.

In a second aspect of the present disclosure, embodiments of the present disclosure relate to a transformer. The transformer includes a winding according to the first aspect of the present disclosure.

In a third aspect, embodiments of the present disclosure relate to a switching power supply. The switching power supply includes a transformer according to the second aspect of the present disclosure.

These and other aspects of the disclosure will be apparent from and elucidated with reference to the embodiment(s) described hereinafter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a schematic diagram of a transformer winding according to an embodiment of the present disclosure;

FIG. 2 illustrates a possible schematic winding wire pattern of the transformer winding of FIG. 1;

FIG. 3 illustrates a schematic diagram of a transformer winding according to another embodiment of the present disclosure;

FIG. 4 illustrates a schematic diagram of a transformer winding according to yet another embodiment of the present disclosure; and

FIG. 5 illustrates a schematic diagram of a transformer winding according to further another embodiment of the present disclosure.

### DETAILED DESCRIPTION

The principles of the present disclosure will now be described with reference to various exemplary embodiments shown in the drawings. It should be understood that the description of these embodiments is merely intended to enable those skilled in the art to better understand and to further practice the present disclosure, and is not intended to limit the scope of the present disclosure in any way. It should be noted that where possible, similar or identical reference numbers may be used throughout the drawings and may indicate similar or identical functionality. One skilled in the art will readily recognize from the following description that alternative embodiments of the structures and methods illustrated herein may be employed without departing from the principles of the disclosure described herein.

As used herein, the term “includes” and its variants are to be read as open-ended terms that mean “includes, but is not limited to.” The term “based on” is to be read as “based at least in part on.” The terms “one example embodiment” and “one embodiment” are to be read as “at least one example embodiment.” The term “a further embodiment” is to be read as “at least a further embodiment.” The terms “first”, “second” and so on can refer to same or different objects. The following text also can include other explicit and implicit definitions.

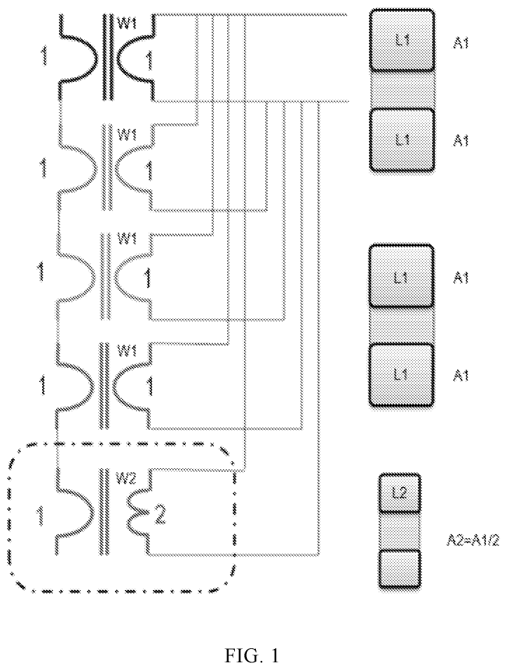

Embodiments of the present disclosure relate to an improved transformer winding. Some illustrative implementations of embodiments according to the present disclosure will be described below with reference to FIGS. 1-5.

FIG. 1 illustrates a schematic diagram of a transformer winding 10 according to an embodiment of the present disclosure. As shown, the transformer winding 10 is provided with five windings, each of which is realized by a corresponding magnetic pole and the wire can be wound to the corresponding magnetic pole to realize a predetermined turns ratio. Specifically, among the five windings, four windings (first windings) W1 are identical to each other, and the four first windings W1 are realized by a first magnetic pole L1 having an area of A1, and a fifth winding (second winding) W2 is realized by a second magnetic pole L2 having an area of A2, according to the embodiment shown in FIG. 1, A2=A½.

In the illustrated embodiment, the primary and secondary sides of the four first windings W1 may be wound with one turn of winding wires, while the number of primary side turns Np2 of the second winding W2 is one turn and the number of secondary side turns Ns2 thereof is two turns.

In the embodiment shown in FIG. 1, the number of primary side turns Np1 and the number of secondary side turns Ns1 in the first winding W1 can be set to 1, so that the cost of winding wire can be minimized while ensuring that a predetermined turns ratio is achieved. In other embodiments, the number of primary side turns Np1 and the number of secondary side turns Ns1 in the first winding W1 may also be set to other integers, and such embodiments are within the scope of the present disclosure.

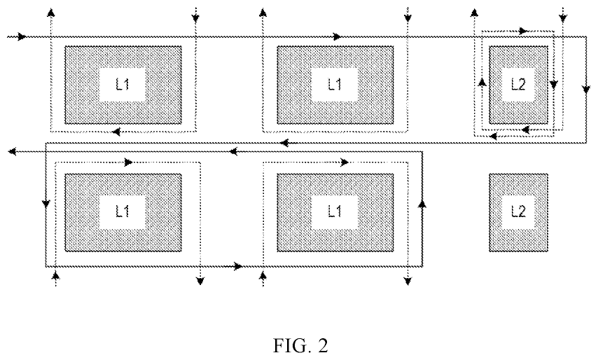

FIG. 2 illustrates a schematic winding wire pattern of the transformer winding of FIG. 1. The winding wire pattern of the primary side is shown by a solid line with an arrow in FIG. 2, and the winding pattern of the secondary side is shown by a dotted line with an arrow. Referring to the solid line of FIG. 2, the primary sides of four first magnetic poles L1 and one second magnetic pole L2 on the graph are coupled in series. Referring to the dotted line of FIG. 2, each of these magnetic poles is individually wound with a secondary side winding. As shown in the figure, the number of primary side turns Np1 and the number of secondary side turns Ns1 of the windings of the four first magnetic poles L1 are the same, both being one turn. The number of secondary side turns Ns2 of the second magnetic pole L2 is 2 turns. Since the primary side windings of the magnet poles are connected in series, 4 magnet poles L1 can achieve a turns ratio of 4:1. Since the second magnetic pole L2 (i.e., the fifth magnetic pole) is connected in series, and the area A2 thereof is half of the area A1 of the first four magnetic poles L1, the second magnetic pole L2 can achieve a turns ratio of 0.5:1. Thus, the winding pattern of the transformer according to FIG. 2 finally results in a turns ratio of 4.5:1.

The number of first windings W1 can be adjusted to achieve different turns ratios. For example, in some embodiments, if the number of first windings W1 is reduced to three, a turns ratio of 3.5:1 may be achieved. In other embodiments, a turns ratio of 6.5:1 may be achieved if the number of first windings W1 is increased to six.

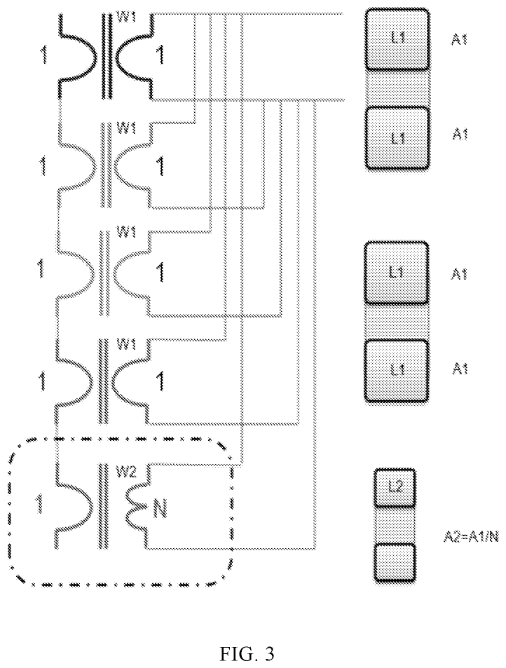

In further embodiments, a more flexible turns ratio can be achieved by adjusting the number of secondary side turns Ns2 in the second winding W2. Reference is made, for example, to FIG. 3, which is a schematic diagram of a transformer winding according to another embodiment of the present disclosure. In the embodiment shown in FIG. 3, as in FIG. 1, the number of first windings W1 is four, but the number of secondary side turns Ns2 in the second windings W2 is N, where N>2. Accordingly, the area A1 of the second magnetic pole L2 and the area A2 of the second magnetic pole L2 satisfy: A2=A1/N. According to the embodiment shown in FIG. 3, the turns ratio of (1/N):1 can be realized on the second magnetic pole L2. Thus, the embodiment of FIG. 3 can achieve the turns ratio of (4+1/N):1. By controlling different N, a finer adjustment of the particle size can be achieved. For example, in some embodiments, when N=4, a turns ratio of 4.25:1 may be achieved. As another example, in other embodiments, when N=5, a turns ratio of 4.2:1 may be achieved.

Similar to FIG. 1, according to the embodiment of FIG. 3, by adjusting the number M of first windings W1, a more flexible and diverse turns ratios can be achieved, i.e., the turns ratio of (M+1/N):1. For example, when the number M of first windings W1 is 6 and the number of second windings W2 is 3, a turns ratio of 6.33:1 can be achieved.

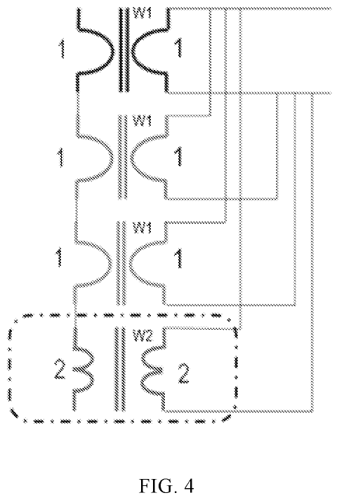

FIG. 4 illustrates a schematic diagram of a transformer winding according to yet another embodiment of the present disclosure. In the embodiment shown in FIG. 4, the number of primary side turns Np2 and the number of secondary side turns Ns2 of the second winding W2 may both be greater than 1 and may be identical. According to the embodiment of FIG. 4, three first windings W1 can achieve a turns ratio of 3:1. Since the number of primary side turns Np2 and the number of secondary side turns Ns2 in the fourth winding, i.e., the second winding W2, are both two, the embodiment shown in FIG. 4 can finally achieve a turns ratio of 4:1 by 3+2/2=4 in combination with the fourth winding.

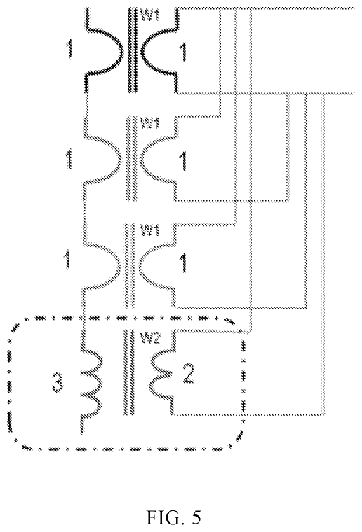

FIG. 5 illustrates a schematic diagram of a transformer winding according to further another embodiment of the present disclosure. In the embodiment shown in FIG. 4, the number of primary side turns Np2 and the number of secondary side turns Ns2 of the second winding W2 may both be greater than 1 and may be different. According to the embodiment of FIG. 5, three first windings W1 can achieve a turns ratio of 3:1. Since the number of primary side turns Np2 and the number of secondary side turns Ns2 in the fourth winding, i.e., the second winding W2, are 3 turns and 2 turns, respectively, the embodiment shown in FIG. 4, in combination with the fourth winding, finally enables a turns ratio of 3+3/2=4.5:1.

Since any non-integer can be split into positive integers and fractions (including proper fractions and mix fractions), various desired turns ratios can be achieved according to embodiments of the present disclosure. For example, to achieve a turns ratio of 6.75, 6.75 may be split into 6+¾, then the number of first windings W1 may be set to 6, while the number of primary side turns Np2 and the number of secondary side turns Ns2 of the second windings W2 are set to 3 and 4 turns, respectively. Further, it is also possible to split 6.75 into 5+7/4, and then it is possible to set the number of the first winding W1 to 5, and set the number of primary side turns Np2 and the number of secondary side turns Ns2 of the second winding W2 to 7 turns and 4 turns, respectively. The user can flexibly achieve a desired turns ratio by adjusting the number of windings and the number of turns of the winding according to cost and the like.

It should be understood that the magnetic poles according to embodiments of the present disclosure are not particularly limited as to the specific form of the magnetic core. For example, in some embodiments, the first magnetic pole L1 may be disposed on both side poles of the U-shaped magnetic core or on the center pole of the E-shaped magnetic core. In this way, the first winding can be realized in various ways. In other embodiments, the second magnetic pole L2 may be disposed on both side poles of the U-shaped magnetic core or on the center pole of the E-shaped magnetic core. In this way, the second winding can be realized in various ways. Referring back to FIG. 2, the two second magnetic poles L2 on the right may be two side poles of a U-shaped magnetic core. In the embodiment shown in FIG. 2, only the upper second magnetic pole L2 is wound with a winding wire, and the lower second magnetic pole L2 is not. It should be noted that this is only one possible way of winding. In other embodiments, the wire may be wound on the lower second magnetic pole L2, while the upper second magnetic pole L2 is not provided with a winding wire. In this way the desired turns ratio can be obtained as well.

Of course, only a few of the possible forms of magnetic cores are listed here, and one skilled in the art could also envision other forms of magnetic cores to implement the windings of embodiments of the present disclosure.

In contrast to prior designs, embodiments of the present disclosure ingeniously propose a winding that achieves a desired turns ratio flexibly and at a lower cost by varying the area of the magnetic pole and the number of turns of the winding. Embodiments of the present disclosure also relate to a transformer including such a winding structure. Such a transformer may be a main transformer for use in a switching power supply, but may of course also be a main transformer for performing other functions. The present disclosure is not particularly limited as to the use scenario of the transformer. By achieving the desired turns ratio, the input and output currents of the transformer can be brought to predetermined values.

It should be understood that although embodiments of the present disclosure have been described with respect to transformers, the concepts of the present disclosure are applicable to other forms of electrical devices. The present disclosure is not particularly limited in this regard.

Although the subject matter has been described in language specific to structural features and/or methodological acts, it is to be understood that the subject matter defined in the appended claims is not necessarily limited to the specific features or acts described above. Furthermore, although claims have been formulated in this application to particular combinations of features, it should be understood that the scope of the disclosure also includes any novel feature or any novel combination of features disclosed herein either explicitly or implicitly or any generalization thereof, whether or not it relates to the same item in any claim as presently claimed.

1. A winding comprising:
one or more first magnetic poles each having a first cross-sectional area equal to each other and each wounded with a first primary side winding and a first secondary side winding, wherein the first primary side windings each has a first number of primary side turns equal to each other and the first secondary side windings each has a first number of secondary side turns equal to each other; and
one or more second magnetic poles each having a second cross-sectional area equal to each other and each wounded with a second primary side winding and a second secondary side winding, wherein the second primary side windings each has a second number of primary side turns equal to each other and the second secondary side windings each has a second number of secondary side turns equal to each other,
wherein the second cross-sectional area is not equal to the first cross-sectional area.

2. The winding of claim 1, wherein the first number of primary side turns is not equal to the second number of primary side turns, and/or the first number of secondary side turns is not equal to the second number of secondary side turns.

3. The winding of claim 1, wherein the first cross-sectional area is N times the second cross-sectional area, N being a positive integer greater than 1.

4. The winding of claim 2, wherein the second number of primary side turns is N times the second number of secondary side turns, N being a positive integer greater than 1.

5. The winding of claim 2, wherein the first number of primary side turns is equal to the first number of secondary side turns.

6. The winding of claim 1, wherein the first magnetic pole is arranged on both side poles of a U-shaped magnetic core.

7. The winding of claim 1, wherein the second magnetic pole is arranged on both side poles of a U-shaped magnetic core.

8. A transformer comprising the winding of claim 1.

9. A switching power supply comprising the transformer of claim 8.

10. The winding of claim 1, wherein the first magnetic pole is arranged on a middle pole of an E-shaped magnetic core.

11. The winding of claim 1, wherein the second magnetic pole is arranged on a middle pole of an E-shaped magnetic core.

12. The winding of claim 2, wherein the first magnetic pole is arranged on both side poles of a U-shaped magnetic core, or the first magnetic pole is arranged on a middle pole of an E-shaped magnetic core.

13. The winding of claim 2, wherein the second magnetic pole is arranged on both side poles of a U-shaped magnetic core, or the second magnetic pole is arranged on a middle pole of an E-shaped magnetic core.

14. The winding of claim 3, wherein the first magnetic pole is arranged on both side poles of a U-shaped magnetic core, or the first magnetic pole is arranged on a middle pole of an E-shaped magnetic core.

15. The winding of claim 3, wherein the second magnetic pole is arranged on both side poles of a U-shaped magnetic core, or the second magnetic pole is arranged on a middle pole of an E-shaped magnetic core.

16. The winding of claim 4, wherein the first magnetic pole is arranged on both side poles of a U-shaped magnetic core, or the first magnetic pole is arranged on a middle pole of an E-shaped magnetic core.

17. The winding of claim 4, wherein the second magnetic pole is arranged on both side poles of a U-shaped magnetic core, or the second magnetic pole is arranged on a middle pole of an E-shaped magnetic core.

18. The winding of claim 5, wherein the first magnetic pole is arranged on both side poles of a U-shaped magnetic core, or the first magnetic pole is arranged on a middle pole of an E-shaped magnetic core.

19. The winding of claim 5, wherein the second magnetic pole is arranged on both side poles of a U-shaped magnetic core, or the second magnetic pole is arranged on a middle pole of an E-shaped magnetic core.

20. A transformer, comprising:
a winding comprising:
one or more first magnetic poles each having a first cross-sectional area equal to each other and each wounded with a first primary side winding and a first secondary side winding, wherein the first primary side windings each has a first number of primary side turns equal to each other and the first secondary side windings each has a first number of secondary side turns equal to each other; and
one or more second magnetic poles each having a second cross-sectional area equal to each other and each wounded with a second primary side winding and a second secondary side winding, wherein the second primary side windings each has a second number of primary side turns equal to each other and the second secondary side windings each has a second number of secondary side turns equal to each other,
wherein the second cross-sectional area is not equal to the first cross-sectional area, and
wherein the first number of primary side turns is not equal to the second number of primary side turns, and/or the first number of secondary side turns is not equal to the second number of secondary side turns.
